(19) United States
(12) Patent Application Publication
(10) Pub. No.: US 2025/0116619 A1
(43) Pub. Date: Apr. 10, 2025

(54) ANTI-COUNTERFEITING OBJECT, METHOD FOR MANUFACTURING SAME, AND USE THEREOF

(71) Applicants: CENTRE NATIONAL DE LA RECHERCHE SCIENTIFIQUE, Paris (FR); UNIVERSITÉ DE LORRAINE, Nancy Cedex (FR)

(72) Inventor: Samuel KENZARI, Andilly (FR)

(21) Appl. No.: 18/833,144

(22) PCT Filed: Feb. 3, 2023
(86) PCT No.: PCT/EP2023/052700

§ 371 Date: Jul. 25, 2024

(30) Foreign Application Priority Data
Feb. 9, 2022 (EP) 22305142.6

(51) Int. Cl. G01N 27/04; B29C 64/171; B29K 101/12; B29K 507/04; B33Y 10/00; B33Y 80/00

(52) U.S. Cl. CPC G01N 27/041; B33Y 10/00; B33Y 80/00; B29C 64/171; B29K 2101/12; B29K 2507/04

(57) ABSTRACT

The application relates to an anti-counterfeiting object manufactured using additive manufacturing by depositing a first electrically insulating material in the fused state. It includes at least one conductor of a second conductive material integrated into the first material, the conductor connecting at least two accessible terminals and having a measurable characteristic resistance between the terminals. The application also relates to a method for authenticating the object.

### FIELD OF THE INVENTION

The invention relates to an anti-counterfeiting object for which it can be established whether it was manufactured authentically. It also relates to the method for manufacturing this anti-counterfeiting object and the authentication method which enables it to be established whether the object is authentic.

### BACKGROUND OF THE INVENTION

Counterfeiting is a longstanding problem that is growing in scope and magnitude. Counterfeiting is a constant concern to businesses because of the impact that it has on sales, brand value and a firm's reputation, as well as on the ability to benefit from technical innovations. Consumers also fall prey to counterfeiting, being defrauded of the genuine product they have paid for and, with regard in particular to goods such as mechanical parts or drugs, running significant health and safety risks. At state level, counterfeiting is a concern for governments because of the threat it poses to the welfare and health of their citizens, the negative impact it can have on innovation, and the substantial resources channeled to criminal networks, organised crime and other groups that disrupt society.

Today, there are a multitude of technologies that can be used in the fight against counterfeiting. For example, nano and other advanced technologies have opened the door to new ways of brand protection, and product tagging and tracing. These technologies offer the potential for uniquely “fingerprinting” a product, leaving it unaffected, or its packaging. In this connection, the report “Nano and other Innovative Anti-Counterfeit Technologies”, published by the Technology Transfer Centre in April 2016, describes over forty mainly very recent solutions.

Current anti-counterfeiting technology options comprise a range of overt and covert measures which enable product authentication. The anti-counterfeiting market can be mainly categorised into two segments, namely authentication technologies and track & trace technologies.

These technology options include serial numbers, barcodes, datamatrix technology and RFID chips for identification, and holograms, biometric solutions, watermarks and taggants for security. These technologies each have their limitations at different levels and are rarely foolproof.

Document WO 2019/011986 A1 discloses a method for identifying an object by including in this object a substance which is observable by X-ray and of which the spectrum of analysis is specific and non-reproducible.

Although this method is highly reliable, it has the drawback of needing unusual means of analysis.

### SUMMARY OF THE INVENTION

The first objective of the invention is thus to provide an object which can be authenticated. Another objective is to provide a method enabling such an object to be manufactured. Still a further objective is to provide a method enabling authentication of an object.

In light of these objectives, the invention is directed to protecting an anti-counterfeiting object manufactured using additive manufacturing by depositing a first, electrically insulating material in the fused state, characterised in that it comprises at least one conductor of a second conductive material integrated into the first material, the conductor connecting at least two accessible terminals and having a measurable characteristic resistance between the terminals.

Additive manufacture by fused filament deposition enables the production of unitary objects. The incorporation of a conductor during this manufacturing process makes it possible to impart a specific feature to the object. This feature can be recognised in order to demonstrate that the object is indeed authentic. In practice, a plurality of conductors are incorporated into the object so as to multiply the possible combinations in terms of resistance value. Few means are needed to access the resistance value, so meaning that checking is easy to carry out using a simple ohmmeter. The anti-counterfeiting object may be the product itself, a part integrated into the product to be authenticated or a part integrated into the packaging. Even though it is theoretically possible to reproduce an object having the same resistance values, in practice such a manufacturing technique exhibits significant scatter and it is difficult to obtain a perfectly predictable result. This difficulty does not arise for the manufacturer of the authentic product as they will not be seeking to achieve a precise value, but rather merely a specific value which can be checked subsequently.

According to one design arrangement, at least one of the terminals is common to two conductors. This limits the number of terminals to be made accessible from outside the object. It is possible, however, to provide each terminal conductor at each end.

According to one design arrangement, the second material comprises a matrix of thermoplastic material and a filler in the form of conductive particles. This material may be thus put to use by way of fused filament technology. This composite is rendered conductive by the conductive particles coming into contact with one another in the thermoplastic material matrix. The conductive particles may in particular be based on carbon, for example graphene or carbon nanotubes. Such a second material is sold, for example, under the name “Proto-Pasta” by the company ProtoPlant. The thermoplastic material in this case is PLA and the conductive filler is carbon black in the form of nanoparticles.

According to one feature, the resistance value is greater than 1 kΩ, preferably greater than 10 kΩ. These values are easily measurable with simple apparatus. Low resistance values are the more difficult to obtain and are not of interest in this specific case.

The invention also provides a method for manufacturing an anti-counterfeiting object as described above, according to which a plurality of layers of the first, electrically insulating material are deposited in the fused state, and the second, conductive material is further deposited to produce at least one conductor integrated into the first material and connecting at least two accessible terminals. Typically, the 3D-printed part is manufactured using at least two print heads, a first head for the first, insulating material and a second head for the second, conductive material. The bulk of the part is produced with the first material, while a conductor deposited by the second head is inserted during production of the layers. Each object produced is unique.

The invention also provides a manufacturing method according to which a batch of objects is manufactured as described above, and at least one of the parameters is modified, from one object to another, for at least one of the conductors from a group comprising the course of the conductor, the cross-section of the conductor over at least part of the course, the material of the conductor, and the number of conductor production passes, so as to modify the resistance value of said conductor. In this way, the properties of each of the manufactured objects is adjusted such that the resistance values of the conductors are specific to each of the objects. An influence is exerted on all the parameters which can determine the resistance of the conductor, be these the course, in particular the length, or the cross-section when making a larger or smaller deposit, or when carrying out a plurality of passes side by side on one and the same layer or superposed in adjacent layers. It is also possible to vary the material used, for example by using a plurality of heads each containing a different material.

The invention also provides a method for authenticating an object from among the batch of objects manufactured as described above, according to which, for each object of the batch, the resistance value of each conductor is measured between the terminals after manufacture and a register is kept by creating a record of the measured values for the object, the object to be authenticated then being considered authentic if the resistance values measured for each of the conductors of said object to be authenticated correspond to the values of one of the records in the register. The manufacturer of the objects, who will have created the register, is in a position to establish whether one of the objects on which the resistance measurement is performed is an object manufactured by them by comparing the measurements with the values in the registers. The comparison is performed with a tolerance to take account of measurement uncertainty. This tolerance is for example between 1 and 5%. Ratios of resistances can be used as the basis for making the comparison.

The invention also provides a method for authenticating an object from among the batch of objects manufactured using the method as described above, according to which a checking device is used which comprises the same number of connectors as the object has terminals, the device being configured such that each connector is in contact with one of the terminals of the object in a checking position, the checking device comprising at least one tester for testing electrical continuity between at least two connectors, the tester giving a positive indication when it detects electrical continuity supplied by the object between two connectors. This method may be carried out in addition to the preceding method, for example as a preliminary step, so as to detect crude reproductions not comprising a conductor between the expected terminals. The checking device is manufactured for example at least in part using the same method for manufacturing as described previously.

According to an improvement of the method, the terminals are distributed according to a pattern repeated regularly about an axis so as to repeat checking positions, and the object is considered to be valid if each tester gives a predetermined positive or negative indication for each of the checking positions of the checking device. There are thus a plurality of checking positions in which the checking device may enter into contact with the terminals. At least one of the positions allows testing. Over all the checking positions, it is possible to have predetermined what the results of the testers should be, and to compare them to the tests actually performed on the object.

### BRIEF DESCRIPTION OF THE FIGURES

The invention will be better understood and other peculiarities and advantages will become apparent on reading the following description, the description making reference to the appended drawings, in which:

FIG. 1 is a perspective view of an object according to the invention;

FIG. 2 is a view similar to FIG. 1 of another object according to the invention;

FIG. 3 is a front view of an object according to the invention according to a second embodiment;

FIG. 4 is a view of a checking device for the object of FIG. 3;

FIG. 5 is a view similar to FIG. 3 according to a third embodiment;

FIG. 6 is a view similar to FIG. 3 according to a fourth embodiment.

### DETAILED DESCRIPTION

An object 1 according to a first embodiment of the invention is shown in FIG. 1. This object 1 is parallelepipedal in form with in particular an upper face 10 on the surface of which are shown four terminals 11, 12, 13, 14. Conductors are represented schematically. A first conductor 15 connects the first and second terminals 11, 12. A second conductor 16 connects the second terminal 12 to a third terminal 13. A third conductor 17 connects the third and fourth terminals 13, 14. The resistance of each of the three conductors 15, 16, 17 may be measured between the terminals 11, 12, 13, 14 to which the ends of the conductor to be measured are connected, for example the first and second terminals 11, 12 for the first conductor 15. The resistance value is almost always greater than 1 kΩ, frequently greater than 10 kΩ, or even greater than 100 kΩ.

The object 1 is manufactured by additive manufacturing by fused filament deposition. A first layer is deposited on a build plate to form the lower face, opposite the upper face 10. Layers are then formed on top of the preceding layer and parallel thereto, stacking of the layers thus producing the finished object 1.

The bulk of the part is produced by deposition of a first, thermoplastic insulating material, for example PLA, ABS, PETG, PA or PEEK. The conductors are integrated into these layers by deposition of a second conductive material different from the first material. Deposition may be carried out in the form of a continuous bead, a plurality of adjacent beads in the same layer or in superposed layers, or portions of adjacent beads in continuous contact. The second material comprises a matrix of thermoplastic material and a filler in the form of conductive particles such as nanoparticles of carbon or of graphene. Terminals 11, 12, 13, 14 are also made of this second material.

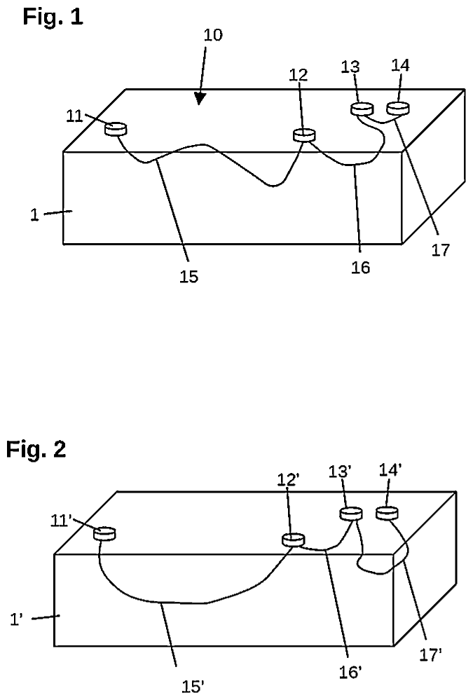

Such objects are manufactured in batches and, from one object 1 to the next, at least one parameter is modified for at least one of the conductors 15, 16, 17 so as to modify the resistance value of said conductor. The parameters which may be modified are the course of the conductor, the cross-section of the conductor over at least part of the course, the material of the conductor, and the number of conductor production passes. In the example of object 1′ shown in FIG. 2, the courses of the three conductors 15′, 16′, 17′, also shown schematically, have been modified relative to the example of FIG. 1, while terminals 11′, 12′, 13′, 14′ remain in the same place.

For each object of the batch, the resistance value of each of the three conductors between the terminals is measured after manufacture. In a register, a record is created with the three values measured for the object.

When it is desired to establish whether an object to be authenticated is authentic, the resistance value is measured for each of the conductors of said object and compared with the values of records in the register. The object to be authenticated is considered to be authentic if there is record in which the three measured resistance values correspond to those of the record.

The object may be the product itself that a consumer buys and for which they wish to be of guaranteed manufacture. The consumer may perform the resistance measurements themselves or with the help of a retailer, the resistance measurements being sent to the manufacturer who holds the register and who can in return indicate whether the object is authentic.

The object may alternatively be incorporated into the product, in such a way that extraction thereof is possible only by breaking part of the product or of the object. The object may also be integrated into a container or packaging for the product.

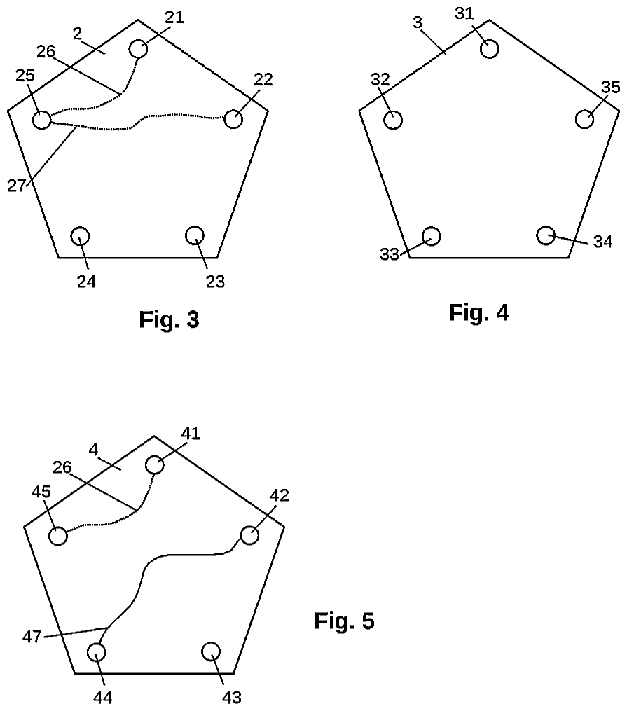

An object 2 according to a second embodiment of the invention is depicted in FIG. 3. This object 2 is substantially in the form of a pentagonally shaped plate. Five terminals 21, 22, 23, 24, 25 are provided flush on the face seen in FIG. 3, distributed regularly around the points of a pentagon inscribed within the contours of the plate. The terminals are distributed according to a pattern repeated regularly about the centre of the pentagon. Conductors 26, 27 respectively connect terminals 21, 25 and 22, 25.

A checking device 3, as shown in FIG. 4, is also substantially in the form of a pentagonal plate. Five connectors 31, 32, 33, 34, 35 protrude from the surface so as to come into contact respectively with terminals 21, 22, 23, 24, 25 of the object 2 by placing the object 2 and the checking device 3 facing one another. The checking device comprises a tester for testing electrical continuity between the connector 35 and the group of connectors 31 and 32. When the connectors are laid against the terminals in a first position, electrical contact is established between connector 31 and terminal 21, between connector 32 and terminal 22 and between connector 35 and terminal 25. The tester then gives a positive indication because it detects electrical continuity passing through connector 35, terminal 25, conductor 26, terminal 21 and connector 31. The positive indication also results from the electrical continuity detected as it passes through connector 35, terminal 25, conductor 27, terminal 22 and connector 32. When the checking device is turned by a fifth of a turn in the clockwise direction to move into a second position, connector 35 is in contact with terminal 21, connector 31 is in contact with terminal 22, etc. The tester then gives a positive indication because it detects electrical continuity passing through the connector 35, terminal 21, conductor 26, conductor 27, terminal 22 and connector 31.

All the other positions give a negative indication. In practice, it is sufficient for two connectors of the tester to link up with two terminals to provide a positive indication. Since the checking device may adopt five different positions, predetermined position sequences may be designed for checking continuity according to a conductor pattern, the tester having to provide a positive indication in certain positions and a negative one in the other positions. In this case, the test is considered positive when the indication is positive solely in the first and second positions.

In one variant, the checking device comprises two testers, not shown but identical in appearance to that of FIG. 4, a first electrical continuity tester between connector 35 and connector 31, and a second continuity tester between connectors 32 and 34. Connectors 31 and 35 are connected electrically together, as are the connectors 32 and 34. When the connectors are laid against the terminals in the first position, the first tester gives a positive indication because it detects electrical continuity passing through connector 35, terminal 25, conductor 26, terminal 21 and connector 31. The second tester gives a negative indication. In the second position, the tester gives a positive indication because it detects electrical continuity passing through connector 35, terminal 21, conductor 26, conductor 27, terminal 22 and connector 31. The second tester continues to give a negative indication.

When the checking device is turned by a further fifth of a turn in the clockwise direction to move into a third position, the two testers give a negative indication.

When the checking device is turned by a further fifth of a turn in the clockwise direction to move into a fourth position, the first tester gives a negative indication. The second tester gives a positive indication by detecting electrical continuity passing through connector 32, terminal 25, conductor 27, terminal 22 and connector 34.

In a third embodiment, shown in FIG. 5, the object 4 is distinguished from that of FIG. 3 in that it comprises a conductor between terminals 41, 45 and another between terminals 42, 44. The checking device, not shown but identical in appearance to that of FIG. 4, comprises a first electrical continuity tester between connector 35 and connector 31, and a second continuity tester between connectors 32 and 34. When the connectors are laid against the terminals in a first position, electrical contact is established between connector 31 and terminal 41, between connector 32 and terminal 42, between connector 34 and terminal 44 and between connector 35 and terminal 45. The first tester then gives a positive indication because it detects electrical continuity passing through connector 35, terminal 45, conductor 46, terminal 41 and connector 31. The second tester likewise gives a positive indication because it detects electrical continuity passing through connector 32, terminal 42, conductor 47, terminal 44 and connector 34. In the second position, the first tester gives a positive indication as a result of the electrical continuity between connector 35, terminal 41, conductor 46, terminal 41 and connector 31. The test is considered positive when the two testers give a positive indication in the first position and only the first tester gives a positive indication in the second position, the indications being negative in the other positions.

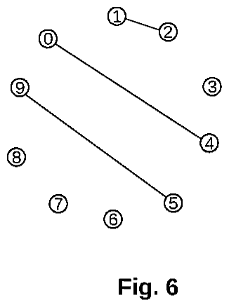

In a fourth embodiment, shown in FIG. 6, the object is distinguished from that of the second embodiment in that it comprises ten terminals, numbered 0 to 9 in FIG. 6, distributed about the vertices of a regular decagon. Conductors connect terminals 1-2, 4-10 and 5-9. The same verification principle can be applied thereto with a checking device comprising connectors also distributed around a decagon of the same diameter. The invention is not limited to the embodiments described by way of example. The surfaces bearing the terminals or the connectors are depicted flat, but they could be in relief.

1. An anti-counterfeiting object manufactured using additive manufacturing by depositing a first, electrically insulating material in the fused state, wherein it comprises at least one conductor of a second conductive material integrated into the first material, the conductor connecting at least two accessible terminals and having a measurable characteristic resistance between the terminals.

2. The object according to claim 1, wherein at least one of the terminals is common to two conductors.

3. The object according to claim 1, wherein the second material comprises a matrix of thermoplastic material and a filler in the form of conductive particles.

4. The object according to claim 1, wherein the resistance value is greater than 1 kΩ.

5. A method for manufacturing an anti-counterfeiting object according to claim 1, according to which a plurality of layers of the first, electrically insulating material are deposited in the fused state, the method further comprising depositing the second, conductive material to produce at least two accessible terminals and at least one conductor integrated into the first material and connecting at least two terminals from among the accessible terminals.

6. The manufacturing method according to claim 5, according to which a batch of objects is manufactured, and at least one of the parameters from a group comprising the course of the conductor, the cross-section of the conductor over at least part of the course, the material of the conductor, and the number of conductor production passes, is modified, from one object to another, for at least one of the conductors so as to modify the resistance value of said conductor.

7. The method for authenticating an object from among the batch of objects manufactured using the method of claim 6, according to which, for each object of the batch, the resistance value of each conductor is measured between the terminals after manufacture and a register is kept by creating a record of the measured values for the object, the object to be authenticated then being considered authentic if the resistance values measured for each of the conductors of said object to be authenticated correspond to the values of one of the records in the register.

8. The method for authenticating an object from among the batch of objects manufactured using the method of claim 6, according to which a checking device is used which comprises the same number of connectors as the object has terminals, the device being configured such that each connector is in contact with one of the terminals of the object in a checking position, the checking device comprising at least one tester for testing electrical continuity between at least two connectors, the tester giving a positive indication when it detects electrical continuity supplied by the object between two connectors.

9. The method according to claim 8, according to which the terminals are distributed according to a pattern repeated regularly about an axis so as to repeat checking positions, and the object is considered to be valid if each tester gives a predetermined positive or negative indication for each of the checking positions of the checking device.
